(19) United States
(12) Patent Application Publication
(10) Pub. No.: US 2024/0392850 A1
(43) Pub. Date: Nov. 28, 2024

(54) Disc Brake for a Utility Vehicle

(71) Applicant: KNORR-BREMSE Systeme fuer Nutzfahrzeuge GmbH, Muenchen (DE)

(72) Inventor: Christian STOEGER, Muenchen (DE)

(21) Appl. No.: 18/696,500

(22) PCT Filed: Sep. 27, 2022
(86) PCT No.: PCT/EP2022/076757

§ 371 Date: Mar. 28, 2024

(30) Foreign Application Priority Data
Sep. 30, 2021 (DE) 10 2021 125 444.2

(51) Int. Cl. F16D 65/18; F16D 55/00; F16D 55/2255; F16D 65/00; F16D 65/095; F16D 125/70

(52) U.S. Cl. CPC F16D 65/18; F16D 55/2255; F16D 65/0068; F16D 65/095; F16D 2055/0016; F16D 2125/70

(57) ABSTRACT

A disc brake for a utility vehicle includes a brake caliper which engages over a brake disc and is held axially displaceable, in relation to the brake disc, on guide rods which are connected to a vehicle-side brake carrier. In the case of a braking operation, an action-side brake pad, which is mounted in the brake carrier and has a pad support plate and a friction lining fastened thereon, can be pressed against the brake disc by an application device which has a pivotable brake lever and a central brake ram. The brake ram has an actuating spindle and a pressure piece contacting the pad support plate. The disc brake is designed in such a manner that the contact region between the brake ram and the pad support plate is inclined towards the entry side of the brake disc, in relation to the forward direction of travel of the utility vehicle.

### BACKGROUND AND SUMMARY

The invention relates to a disc brake for a utility vehicle.

Disc brakes of the type in question are used, in particular, in heavy utility (commercial) vehicles, wherein the brake caliper, which is also denoted as a sliding caliper, is mounted so as to be axially displaceable in relation to a brake disc by guide rods which are fastened to a vehicle-side brake carrier.

The guide rods are generally fastened to the brake carrier by screw connections and are guided in sliding bushings of the brake caliper, such that the brake caliper is axially displaced during a braking operation in relation to a brake disc which is held fixedly in terms of rotation on an axle of the vehicle.

However, the plurality of loads which occur in driving mode, primarily when traveling forward, result in torques which lead to increased wear of the pads, in the form of oblique wear on the action-side, i.e. the application-side, brake pad in the region of the entry side of the brake disc.

Such torques are produced, for example, in the case of a highly eccentric point of application of force on the brake caliper, as can be present in driving mode.

The weight of a brake cylinder held on the brake caliper also contributes to the uneven loading of the action-side brake pad which, in particular, occurs in the case of an application device which has a central brake ram, wherein this brake ram is oriented axially parallel to the axis of rotation of the brake disc.

This oblique wear results in a whole series of drawbacks, both regarding the operation of the disc brake and regarding the service life of the brake pads.

The sum of the aforementioned negatively acting torques ultimately leads to the action-side brake pad being loaded unevenly during a braking operation, so that the braking effect is not achieved to the extent which should be possible, and this results in the aforementioned oblique wear.

The oblique wear also results in at least the action-side brake pad having to be prematurely replaced, since the entry-side region of the brake pad has already reached a permissible wear limit when the opposing region, i.e. the outlet-side region, has not yet reached the wear limit.

The object of the invention is to develop a disc brake of the type in question such that the service life is increased and thus the operating costs are reduced and the functional reliability improved.

This object is achieved by a disc brake having a brake caliper which engages over a brake disk in use and is held axially displaceable, in relation to the brake disk, on guide rods which are connected to a vehicle-side brake carrier, wherein, in the case of a braking operation, an action-side brake pad, which is mounted in the brake carrier and has a pad support plate and a friction lining fastened thereon, is pressed against the brake disk by an application device which has a pivotable brake lever and a central brake ram. The brake ram has an actuating spindle and a pressure piece contacting the pad support plate. A contact region between the brake ram and the pad support plate is inclined toward an entry side of the brake disk in relation to a forward direction of travel of the utility vehicle.

As has been shown, it is achieved by this structural embodiment that in the case of a braking operation, the application-side brake pad is pressed onto the brake disc with the same surface pressure distributed over the friction surface. The sum of the effective torques is positively influenced and uniform wear of the pad is achieved.

As a result, this leads to the service life of the brake pad being increased, resulting in significant cost advantages since a brake pad can now be changed later than was previously the case.

The contact region between the brake ram and the pad support plate, which according to the invention is inclined, can be implemented in various ways.

Thus the pad support plate can be configured obliquely, either as a recess or over the entire surface area, at least in some regions on its rear face facing the brake ram or the pressure piece, wherein the thickness of the pad support plate reduces toward the entry side of the brake disc.

Alternatively or additionally, on its contact surface facing the pad support plate the pressure piece can also be configured to be inclined in the direction of the entry side, i.e. this contact face runs at an acute angle to the longitudinal axis of the brake ram, deviating from a right angle.

For reasons of strength, the partial inclination of the pad support plate in the contact region with the pressure piece is preferred, wherein the contact surface can be rotated with its direction of inclination at an acute angle to a longitudinal axis of the brake pad. As a result, in addition to avoiding tangential oblique wear of the brake pad, it is achieved that radial oblique wear is also prevented.

This radial oblique wear results from the dead weight of the application device which can act in different directions, depending on the mounting position on the vehicle. Equally, different relative speeds between the inner and outer region on the brake pad can lead to radial oblique wear.

The configuration of the pad support plate according to the invention can be produced in a particularly simple manner, in particular when the pad support plate is formed from cast iron, preferably from a spheroidal graphite iron.

Moreover, the invention can also be implemented when the disc brakes are already in use, since only the application-side brake pad with the inclined contact surface has to be replaced.

Since the pressure piece is generally held on the actuating spindle as a separate part, and as a rotational movement of the actuating spindle is required for the re-adjustment while the pressure piece is held fixedly in terms of rotation in relation to the brake pad, the invention can also be used in an existing system by replacing the pressure piece, in particular when changing the brake pad.

Preferably, the angle of inclination of the contact region is <5°, preferably 0.5° to 5°, particularly preferably 1°, in relation to the side of the pad support plate assigned to the brake pad.

Further advantageous embodiments of the invention are characterized in the dependent claims.

Exemplary embodiments of the invention are described hereinafter with reference to the accompanying drawings.

### BRIEF DESCRIPTION OF THE DRAWINGS

FIG. 1 shows a disc brake according to the prior art in a partially sectional plan view;

FIGS. 2 and 3 show, in each case, an exemplary embodiment of the invention in a sectional plan view;

FIG. 4 shows a brake pad according to an embodiment of the invention in a perspective view; and

FIG. 5 shows a further exemplary embodiment of a brake pad according to the invention in a rear view.

### DETAILED DESCRIPTION OF THE DRAWINGS

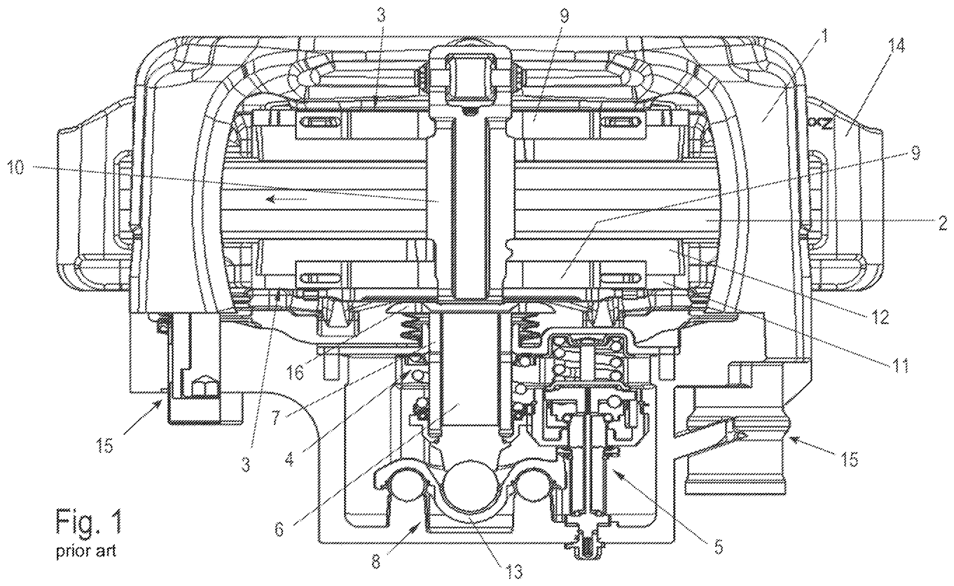

A disc brake according to the prior art is illustrated in FIG. 1 in a schematic view, comprising a brake caliper 1 which engages over a brake disc 2, which is configured as a sliding caliper and in which two brake pads 3 are arranged, said brake pads being able to be pressed against the rotating brake disc 2 during a braking operation. The rotational direction of the brake disc 2 during forward travel is indicated by an arrow.

During the braking operation, initially the application-side brake pad 3 is pressed against the brake disc 2 by means of an application device 8, while due to reaction forces the reaction-side brake pad 3 is subsequently pressed against the brake disc 2 by being entrained by the displaced brake caliper 1.

Each brake pad 3 consists of a pad support plate 11 and a friction lining 12 which is fastened thereto and which is contact with the brake disc 2 during a braking operation.

In each case a pad retaining spring 9 is fastened to the pad support plates 11, said pad retaining spring, in cooperation with a retaining bracket 10, holding the brake pads 3 under pretension in a brake shaft of the brake caliper 1 or a vehicle-side brake carrier 14.

Relative to the axis of rotation of the brake disc 2, the brake caliper 1 is axially displaceably mounted on guide rods 15 which are connected to the brake carrier 14.

The application device 8 has a brake ram 4 which is centrally arranged and which can be pressed axially displaceably against the application-side brake pad 3 via a brake lever 13, wherein the brake lever 13 bears via a bearing ball against the brake ram 4.

The brake ram 4 consists of a threaded spindle 6 to which a re-adjusting device 5 is connected for compensating for clearance, and an actuating spindle 7 which is configured as a threaded sleeve and which engages with an internal thread in an external thread of the threaded spindle 6, and which is fixedly connected with its front face, which faces the pad support plate 11 of the application-side brake pad 3, to a pressure piece 16 which bears securely against the pad support plate 11 in the rotational direction so that the actuating spindle 7 is held fixedly in terms of rotation.

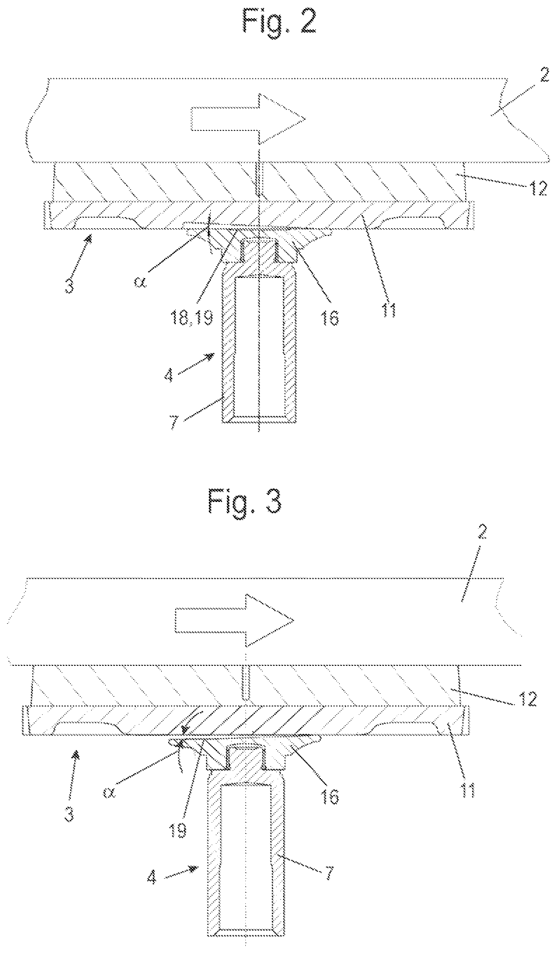

In FIGS. 2 and 3, a part of the disc brake is illustrated in each case in a schematic view, and namely the application-side brake pad 3, the brake disc 2 which is contacted thereby in the case of a braking operation, and the brake ram 4, with the actuating spindle 7, the pressure piece 16 being attached to the end thereof facing the brake pad 3, and namely such that it is fixed in terms of rotation relative to the brake pad 3 but the actuating spindle 7 is rotatable.

According to the invention, the contact region between the brake ram 4 and the pad support plate 11 is inclined toward the entry side of the brake disc 2, in relation to the forward direction of travel of the utility vehicle.

To this end, in the example shown in FIG. 2, a contact surface 18 of the pad support plate 11 is inclined in the direction opposing the rotational direction of the brake disc 2 identified by the arrow, while the assigned contact surface 19 of the pressure piece 16 runs parallel to the side of the pad support plate 11 bearing the friction lining 12, i.e. at right-angles to the longitudinal axis of the brake ram.

In the example shown in FIG. 3, the contact surface 19 of the pressure piece 16 is inclined in the direction of the entry side of the brake disc 2, wherein the entry side is on the left-hand side in FIGS. 2 and 3.

Relative to the example according to FIG. 2, the rear face of the pad support plate 11 in the example shown in FIG. 3 is continuously parallel to the opposing side bearing the friction lining 12.

In any case, during a braking operation, i.e. when the brake pad 3 is applied, the region of the pressure piece 16 located in the outlet direction initially comes to bear against the pad support plate 11, whereby the friction lining 12 in the outlet-side region is subjected to greater load than in the entry-side region.

The angle of inclination a of the contact surfaces 18, 19 is <5°, preferably 0.5° to 5°, in particular approximately 1°, in relation to the side of the pad support plate 11 bearing the friction lining 12.

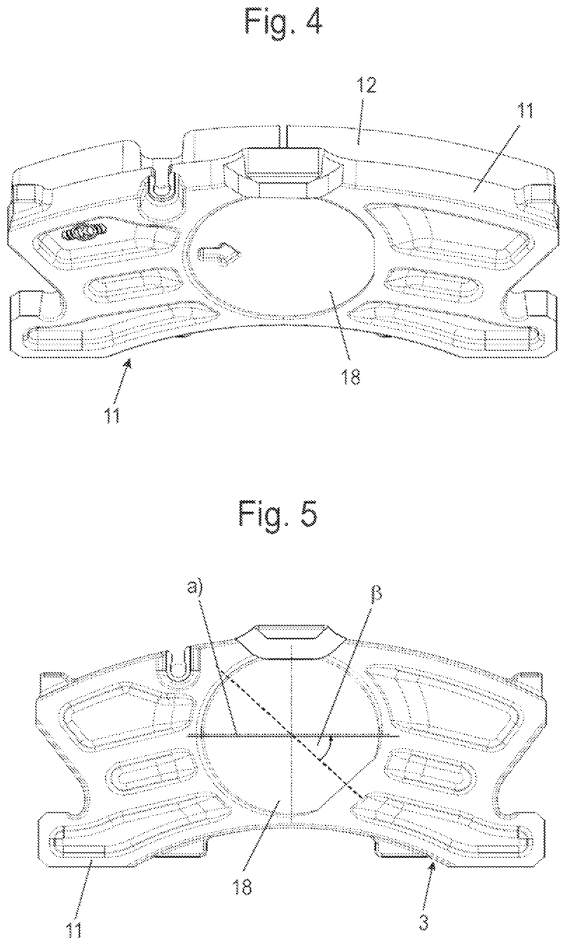

In FIGS. 4 and 5, an exemplary embodiment of a brake pad 3 according to the invention is shown in each case as a detail.

The contact surface 18 is configured to be approximately circular in contour, with a diameter which corresponds approximately to the diameter of the contact surface 19 of the pressure piece 16.

In the brake pad 3 according to FIG. 4, the inclination of the contact surface 18 runs in the direction of the longitudinal extent of the brake pad 3, which can be identified by the reference sign a) in FIG. 5.

The inclination of the contact surface 18 in the example shown in FIG. 5, however, runs at an acute angle β to the longitudinal extent a) of the pad support plate 11. The direction of inclination can be identified here by a dashed line. The angle β is preferably 45°, as shown, wherein the contact surface 18, as mentioned above, is arranged on the side of the pad support plate 11 opposing the friction lining 12.

The angle β can also be greater than or less than 45°. The inclination of the contact surface 18 can also be configured in the opposing direction, in the drawing plane to the right, in order to counteract possible tangential wear of the friction lining 12.

As an alternative to the partially inclined configuration of the contact surface 18, the inclination can extend over the entire length of the pad support plate 11, wherein this pad support plate is inclined to the left in the mounted position of the brake pad 3.

### LIST OF REFERENCE SIGNS

1 Brake caliper
2 Brake disc
3 Brake pad
4 Brake ram
5 Re-adjustment device
6 Threaded spindle
7 Actuating spindle
8 Application device
9 Pad retaining spring
10 Retaining bracket
11 Pad support plate
12 Friction lining
13 Brake lever
14 Brake carrier
15 Guide rod
16 Pressure piece
17 Bridge
18 Contact surface
19 Contact surface

1.-15. (canceled)

16. A disk brake for a utility vehicle, comprising:
a brake caliper which engages over a brake disk in use and is held axially displaceable, in relation to the brake disk, on guide rods which are connected to a vehicle-side brake carrier, wherein
in the case of a braking operation, an action-side brake pad, which is mounted in the brake carrier and has a pad support plate and a friction lining fastened thereon, is pressed against the brake disk by an application device which has a pivotable brake lever and a central brake ram,
the brake ram has an actuating spindle and a pressure piece contacting the pad support plate,
a contact region between the brake ram and the pad support plate is inclined toward an entry side of the brake disk, in relation to a forward direction of travel of the utility vehicle.

17. The disk brake as claimed in claim 16, wherein
the contact region has a contact surface which is incorporated in a side of the pad support plate facing away from the friction lining and which is inclined toward the entry side of the brake disk.

18. The disk brake as claimed in claim 16, wherein
a pressure piece contact surface of the pressure piece facing toward the pad support plate is inclined toward the entry side of the brake disk.

19. The disk brake as claimed in claim 17, wherein
an angle of inclination (α) of the contact surface is <5° in relation to the side of the pad support plate facing the friction lining.

20. The disk brake as claimed in claim 19, wherein
an angle of inclination (α) of the contact surface is 0.5° to 5° in relation to the side of the pad support plate facing the friction lining.

21. The disk brake as claimed in claim 17, wherein
the inclination of the contact surface runs in a longitudinal direction of the pad support plate.

22. The disk brake as claimed in claim 17, wherein
the inclination of the contact surfaces runs at an acute angle to the longitudinal extent of the pad support plate.

23. The disk brake as claimed in claim 17, wherein
the contact surface is configured to be substantially circular and, in terms of its diameter, corresponds approximately to a diameter of the applied pressure piece.

24. The disk brake as claimed in claim 18, wherein
an angle of inclination (α) of the pressure piece contact surface is <5° in relation to the side of the pad support plate facing the friction lining.

25. The disk brake as claimed in claim 24, wherein
an angle of inclination (α) of the pressure piece contact surface is 0.5° to 5° in relation to the side of the pad support plate facing the friction lining.

26. The disk brake as claimed in claim 18, wherein
the inclination of the pressure piece contact surface runs in a longitudinal direction of the pad support plate.

27. A brake pad for a disk brake for a utility vehicle, comprising:
a pad support plate, and
a friction lining which is fastened to the support plate, wherein
on a side opposing the friction lining, the pad support plate is inclined at least in some regions in a longitudinal extent and/or transversely thereto, in relation to the side facing the friction lining.

28. The brake pad as claimed in claim 27, wherein
on a side facing away from the friction lining, the pad support plate has a contact surface which is inclined in the longitudinal direction and/or at an acute angle thereto.

29. The brake pad as claimed in claim 27, wherein
an angle of inclination is <5° in relation to the side of the pad support plate facing the friction lining.

30. The brake pad as claimed in claim 27, wherein
an angle of inclination is 0.5° to 5° in relation to the side of the pad support plate facing the friction lining.

31. The brake pad as claimed in claim 27, wherein
the contact surface is configured to be circular.

32. The brake pad as claimed in claim 27, wherein
the contact surface is centrally arranged.

33. The brake pad as claimed in claim 27, wherein
the contact surface or a rear face of the pad support plate facing away from the friction lining is inclined to the left in a mounted position of the brake pad.

34. A brake ram of an application device of a disk brake, comprising:
an actuating spindle; and
a pressure piece which is attached to a front face of the actuating spindle and which has a contact surface on a side facing away from the actuating spindle,
wherein the contact surface is inclined in relation to the longitudinal axis of the actuating spindle.

35. The brake ram as claimed in claim 34, wherein
the angle of inclination (α) is <5° at a right angle to the longitudinal axis of the adjusting spindle.
